(19) United States
(12) Patent Application Publication
(10) Pub. No.: US 2004/0096260 A1
(43) Pub. Date: May 20, 2004

(54) Abrasive soap and handling mechanism

(76) Inventor: Dean L. Rhoades, Los Angeles, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/295,397

(22) Filed: Nov. 14, 2002

(51) Int. Cl. B43K 8/10

(52) U.S. Cl. 401/8; 401/201

(57) ABSTRACT

An apparatus and method for using and manufacturing a dermabrasion and cleansing article. The article includes a handle to hold a composition containing abrasive crystals for polishing an area of skin to remove abnormalities in the skin. The composition also contains cleansing agents.

### BACKGROUND

(1) Field of the Invention

An article for skin treatment and method for application and manufacturing.

(2) Background

Facial skin rejuvenation has been accomplished by chemical treatments referred to as “chemical peels,” laser treatment referred to as “laser surgery” and exfoliation by machine driven means, such as with emery paper. Such methods generally require medical supervision and involve some risk of deleterious effects as well as pain and discomfort during treatment. These methods all require long recovery time between treatments.

Dermabrasion (e.g., microexfoliation, particle skin resurfacing) is a technique in skin care in which a controlled exfoliation of the skin is performed to improve and remove skin abnormalities. A typical dermabrasion machine consists of a compressor to project inert crystals of corundum (aluminum oxide or alumina) through a tube into a hand piece manipulated by a technician over the skin of the subject. The compressor projects the corundum across the skin with variable pressure while the hand piece is in contact with the skin. This induces an abrasion action, which removes the top layer of skin. At the same time, through another tube within the hand piece, the used corundum and abraided skin are vacuumed into another container for disposal. As can be appreciated, the need for the compressor, the supply of corundum, and a vacuum source and disposal container are suitable for a specialty clinic with trained technicians.

This treatment method is expensive and requires complicated machinery and trained technicians. An inexpensive method and apparatus for use by consumers for carrying out dermabrasion is needed.

### BRIEF DESCRIPTION OF THE DRAWINGS

The claims are illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

FIG. 1 is a perspective view of a soap composition with handle.

FIG. 2 is a perspective view of a soap composition with handle including a protective base.

FIG. 3 is a perspective view of handle with a protective base.

FIG. 4A is a perspective view of an elliptical shaped soap composition and handle.

FIG. 4B is a perspective view of a bar shaped soap composition and handle.

FIG. 5 is a perspective view of a circular soap composition held by a human hand.

### DETAILED DESCRIPTION

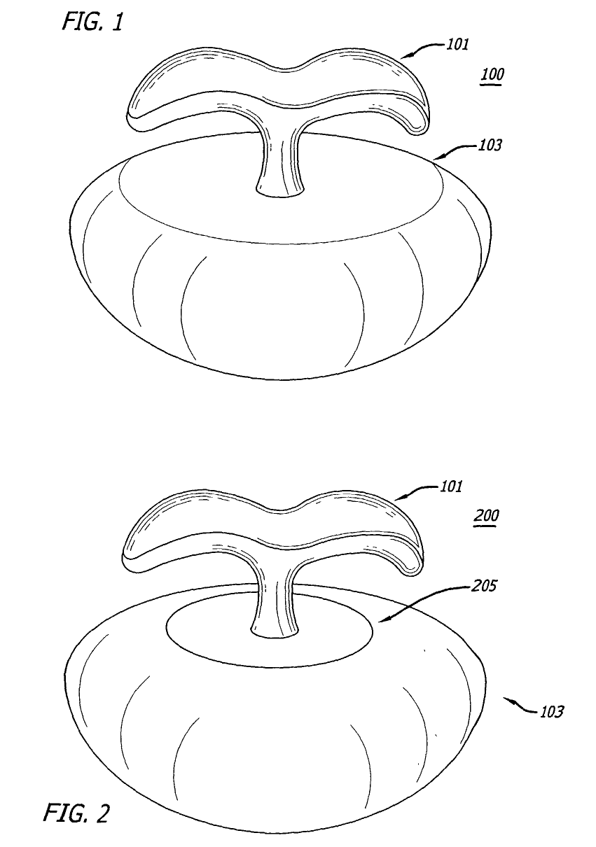

FIG. 1 illustrates one embodiment of a dermabrasion article 100. Dermabrasion article 100 includes dermabrasive soap composition 103 and handle 101, which is configured to be used by a single hand between two fingers. In one embodiment, dermabrasive soap composition 103 is attached to handle 101 by forming composition 103 around a base of the handle (not shown) to secure handle 101 in relation to composition 103.

In one embodiment, composition 103 is a soap-based composition including dermabrasion materials. The composition 103 includes a base comprising, as a principal component, soap suitable for application to human skin. A plurality of abrasive particles are combined in a mixture with the base. The abrasive particles in the mixture are suitable for use in dermabrasion techniques. The abrasive particles may be inorganic particles such as corundum (or aluminum oxide, alumina, Al₂O₃), magnesium oxide (MgO), diamonds, garnets, sapphires, rubies, emeralds, topaz, and other similar materials and precious stones. In one embodiment, the abrasive particles are natural particles of the materials (compounds) described, because the natural particles tend to be hard with generally sharp edges that, when used as described herein, are suitable for resurfacing human skin. Synthetic particles of the materials described may be substituted, as can certain organic polymers (e.g., polymer beads—generally round). In still another embodiment, the abrasive particles are mixtures of two or more suitable materials (e.g., a natural material and a synthetic material).

In one embodiment, the abrasive particles are crystals of a natural material such as corundum having an average particle size on the order of 34 micrometers to 556 micrometers (320 to 30 grit). These particles may be described herewith as “crystals” or “microcrystals.” In one embodiment, the average particle size of the microcrystals is on the order of about 42 micrometers to 198 micrometers (280 to 60 grit).

In one embodiment, the abrasive materials in composition 103 are corundum or other crystals and constitute 5 to 50 percent by weight of composition 103. In one embodiment, they constitute 5 to 25 percent by weight of composition 103. In another embodiment, they constitute 5 to 15 percent by weight of composition 103. The crystals are mixed evenly throughout composition 103.

In one embodiment, the grit size of the crystals of composition 103 range from 50 to 240 (approximately 680 microns to 40 microns). The mean size of the crystals is approximately 50 grit (254 to 420 microns).

The abrasive nature of the particles in the composition 103 render the composition 103 suitable as an exfoliant to improve the look and feel of an area of human skin and remove skin abnormalities. More specifically, the abrasive particles tend to resurface and possibly remove the outer layer of skin (the epidermis) to expose an underlayer of skin. The human body responds by producing a new layer of skin. With one or more (preferrably a series) of such treatments, it is believed that the skin subject to the treatment may be improved. Such improvements include improvement in the appearance of fine lines, wrinkles, stretch marks, non-inflammatory acne, acne scars, surgical scars, rough or coarse textured skin, age spots, blotchy skin conditions and sun damaged skin. The crystals on the surface of composition 103 when pressed against human skin can act to polish away dead epidermal skin. This effects the removal of epidermal blemishes and lines in the skin by removing the outer layer of dead skin, leaving behind healthy unblemished skin below.

In one embodiment, particles of luffa, natural sponge or artificial sponge comprise a portion of composition 103. The luffa and sponge act as a shock and pressure absorbent material in connection with the abrasive crystals. This enables the abrasive crystals to apply the proper pressure to skin being treated in order to remove the dead epidermal skin without damaging living skin below. The luffa and sponge on the surface of composition 103 also assist in cleansing the surface of the skin of a user. The average size of the luffa and sponge particles range in one embodiment from 1/64 inch particles to ⅛ inch particles. In one embodiment, the average size of the luffa and sponge particles is approximately 1/32 inch. The luffa or sponge particles are evenly mixed throughout composition 103 and may constitute, in one embodiment, between 10 percent and 30 percent by weight of composition 103. In one embodiment, the luffa or sponge particles are approximately 12.5 percent by weight of composition 103.

In one embodiment, other additives are made a part of composition 103 to enhance the cleansing, aesthetic, fragrant, dermabrasion, texture or similar properties relevant to a bath soap and dermabrasion product. Other additives may include but are not limited to antioxidants, vitamins (particularly vitamins A, C and E), emulsifiers, toners, acids (e.g., glycolic acid), scrubs, serums, lotions, liquids, elixirs, sun screens and tonics. In one embodiment, composition 103 is approximately 12.5 percent sea kelp. Sea kelp assists composition 103 in delivering vitamins and other nutrients to the skin. Sea kelp can deliver substances to the skin including iodine, amino acids and vitamins (e.g., vitamins A, C, B12, E, Thiamin, etc.).

In another embodiment, essential oils are added to composition 103 to provide a pleasing fragrance for the consumer. In one exemplary embodiment, composition 103 is 37.5 percent by weight of lavender essential oil. Essential oils carry fragrances, vitamins, nutrients and similar substances. Essential oils also act to moisturize skin. In one embodiment, the remainder of composition 103 is a glycerin soap or similar cleansing agent. In one embodiment the soap is a 120 grain glycerin soap. Other cleansing agents may be used in place of or in combination with glycerin including salicylic acid, a lauryl sulfate (e.g., sodium lauryl sulfate or sodium laureth sulfate), or other soaps, cleansing agents or similar materials that can be used on human skin. Other components such as surfactants, antioxidants and antimicrobial or bactericidal agents may be included in composition 103.

The abrasive particles suspended in the soap provide gentle dermabrasion of the skin for resurfacing/rejuvenating the skin, leaving it smooth and soft after each treatment without the need for any recovery time so that it may be repeated as often as on a daily basis, in order to reduce and erase fine lines and wrinkles, reduce pore size, reduce or erase sun damage, age spots and skin discoloration, firm skin and muscle tone, thereby to reduce sagging, enhance new epidermal cells and decongest acne skin conditions. This method of rejuvenate ng the skin, and particularly the facial skin is ideal for those unwilling or unable to undergo laser surgery, a chemical peel or machine driven exfoliation.

In one embodiment, the height of the article including composition 103 and handle 101 is approximately 3.5 inches. Handle 101 is approximately two inches in length across the top *cross bar of the T-shape. The diameter of the circular embodiment of article 100 is approximately four inches. In one embodiment, the lower surface of the circular embodiment of article 100 is convex, providing a higher ratio of skin contact with the lower surface area to improve the quality of the application of article 100 in a dermabrasive application to the skin.

FIG. 2 illustrates an embodiment of a dermabrasion article including handle 101 attached to composition 103. Handle 101 is coupled to protective disk 205. Protective disk 205 rests on the upper surface of the composition 103. Protective disk 205 shields a hand of a user when using the article 200 from composition 103. This prevents unnecessary wear on the upper surface of composition 103 and protects the hand of a user from excess exfoliation from contact with article 200. Protective disk 205 may be any roughly two dimensional shape that covers the upper surface of composition 103 near the protrusion of handle 101 at least over an area having dimensions to accommodate two fingers between post 207 of handle 101.

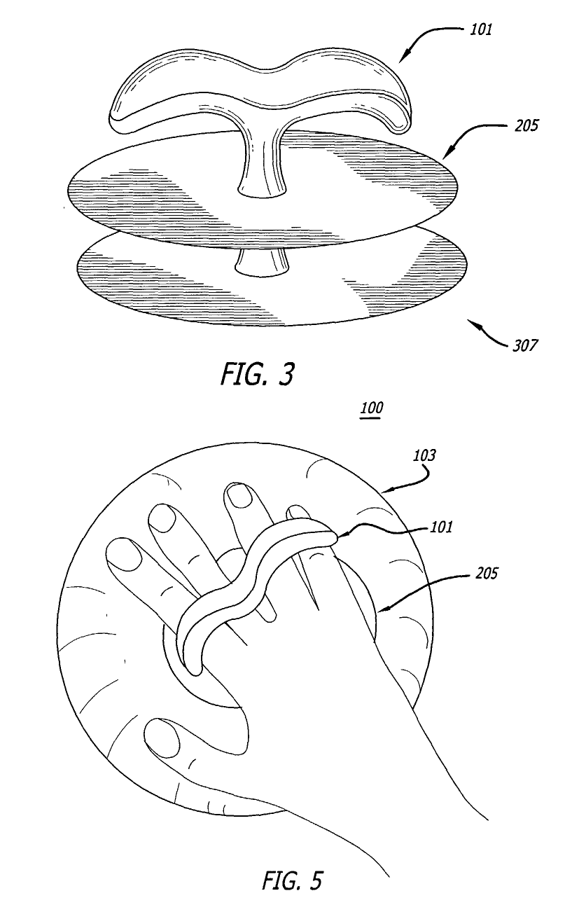

FIG. 3 illustrates handle 101 with protective disk 205. In one embodiment, handle 101 is T-shaped. The under sides of the top cross bar of the T-shape are curved to comfortably fit at least two fingers. Handle 101 includes a lower disk structure 307 around which composition 103 is formed. Handle 101, including base disk 205 and lower disk structure 307 is composed of a plastic material such as polyvinyl chloride (PVC) or other suitable materials for making handles for soap. Handle 101 including lower disk structure 307, with or without protective disk 205, can be formed as a single integral piece of plastic or similar materials. In one embodiment, handle 101 is composed of separate hard plastic pieces corresponding to the T-shape, protective disk 205 and lower disk structure 307. The separate pieces are tapped through the center to provide a threaded hole for a central screw to fasten the pieces together. Other types of fasteners such as nut, bolts, clasps, and similar fasteners can be used to secure the separate process together.

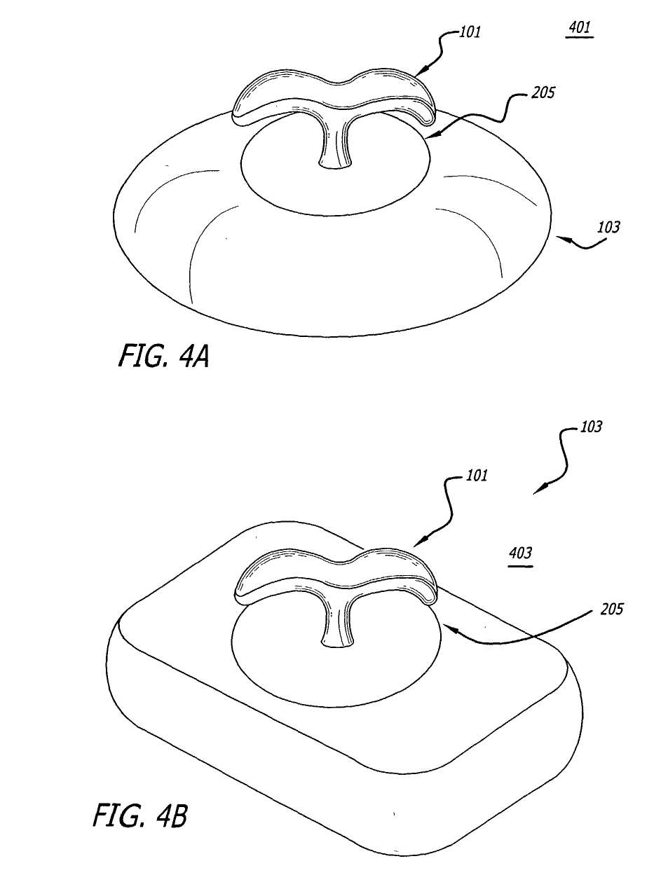

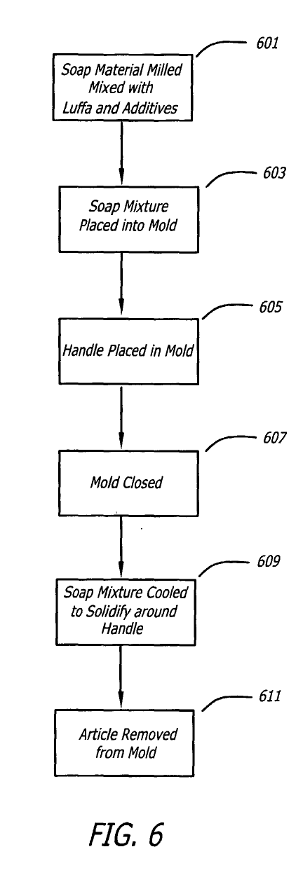

FIGS. 4A and 4B illustrate an embodiment having non-circular composition 103 shapes. In one embodiment, article 401 has a substantially elliptical shape with handle 101 including base protective disk 205 at the center of composition 103. An elliptical shape further improves the ratio of bottom surface area to skin area and facilitates linear dermabrasive application of article 401. In another embodiment, article 403 is substantially bar shaped like a conventional bar of soap, with the exception of handle 101 component including protective base 205. Use of a conventional bar shape allows article 403 to be used conveniently in connection with soap dishes and holders designed for bar soap. In one embodiment, compositions 103 of articles 401 and 403 include a convex or concave lower surface to improve contact between the lower surface and human skin to be cleaned and exfoliated. In one embodiment, composition 103 is saddle shaped, including a relatively flat upper surface and a concave lower surface to facilitate application to areas of human skin, especially those areas that are roughly convex is shape.

In one embodiment, any three dimensional shape can be used for composition 103. In another embodiment, composition 103 and handle 101 are shaped to facilitate application to a human face. This may include narrower surface areas for composition 103 and gripping structures in place of handle 101 that are for use by at least a thumb and finger to provide a greater degree of precision in applying the composition 103 to an area of skin on the face.

FIG. 5 illustrates a hand using an embodiment of article 100. Article 100 is held by at least two fingers on a hand placed below the cross bar of handle 101. The hand rests between the top cross bar of handle 101 and the protective disk 205. Article 100 is used by moving it over the surface of an area of skin to be treated and cleansed. Article 100 can be applied to skin in combination with water similar to typical solid bath soaps.

FIG. 6 is a flow chart for one embodiment of manufacturing article 100. In one embodiment, composition 103 is formed from milled soap and mixed with abrasive crystals, luffa or sponge particles as well as desired additives (block 601) to form a mixture. The soap mixture is poured into a mold while in a hot and pliable form (block 603). Lower disk structure 307 of handle 101 is also placed in the mold (block 605). Molds of varied shapes and sizes can be used to form soaps as desired. After the mold has been filled and closed (block 607), while the soap mixture and additives encompass lower disk structure 307 of handle 101, the mixture is cooled until it solidifies (block 609). The solid composition is then removed from the mold (block 611). Other techniques for forming bars of soap can also be used as extrusion and similar techniques for creating shaped compositions

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

What is claimed is:

1. An apparatus comprising:
a solid composition including a plurality of abrasive particles and a plurality of cleansing agents; and
a handle protruding from a first side of the composition shaped to be held between at least two fingers.

2. The apparatus of claim 1, wherein the plurality of abrasive particles includes corundum crystals.

3. The apparatus of claim 1, wherein the composition includes luffa pieces.

4. The apparatus of claim 1, wherein the composition includes pieces of sponge.

5. The apparatus of claim 1, wherein the composition has a shape that is substantially a disc.

6. The apparatus of claim 1, wherein a protruding section of the handle is substantially T-shaped.

7. The apparatus of claim 6, wherein a top portion of the handle is curved to comfortably fit a human hand when gripped by at least two fingers.

8. The apparatus of claim 1, wherein the composition is formed around a bottom section of the handle to secure the handle to the composition.

9. The apparatus of claim 1, wherein the cleansing agent is glycerin soap.

10. An apparatus comprising:
a cleansing and exfoliation means including a plurality of abrasive particles and a plurality of cleansing agents; and
a gripping means to enable a human hand to hold the cleansing means.

11. A method comprising:
gripping a handle protruding from a first side of a solid composition shaped to be held between at least two fingers, the composition including a plurality of abrasive particles and a plurality of cleansing agents; and
applying the composition to an area of human skin.

12. The method of claim 11, wherein the plurality of abrasive particles includes corundum crystals.

13. The method of claim 11, wherein the composition includes luffa pieces.

14. The method of claim 11, wherein the composition includes pieces of sponge.

15. The method of claim 11, wherein the composition has a shape that is substantially a disc.

16. The method of claim 11, wherein a protruding section of the handle is substantially T-shaped.

17. The method of claim 16, wherein a top portion of the handle is curved to comfortably fit a human hand when gripped by at least two fingers.

18. The method of claim 11, wherein the composition is formed around a bottom section of the handle to secure the handle to the composition.

19. The method of claim 11, wherein the cleansing agent is glycerin soap.

20. A method comprising:
filling a mold containing a first end of a handle structure with a composition;
solidifying the composition around the first end to form a dermabrasion article.

21. The method of claim 20, wherein the composition includes a cleaning agent.

22. The method of claim 20, wherein the composition includes luffa particles.

23. The method of claim 20, wherein the composition includes abrasive crystals to exfoliate dead skin of a user.

24. The method of claim 21, wherein the cleansing agent is a milled soap.

25. A composition comprising:
a plurality of abrasive particles;
a plurality of cleansing agents; and
a plurality of porous mass particles,
wherein the composition is in a form suitable for use in cleansing a body.

26. The composition of claim 25, wherein the porous mass particles are at least one of pieces of sponge and pieces of luffa.

27. The composition of claim 25, wherein the abrasive particles are at least one of corundum crystals and precious stones.
